(19) United States
(12) Patent Application Publication
(10) Pub. No.: US 2006/0119679 A1
(43) Pub. Date: Jun. 8, 2006

(54) Drawing liquids

(75) Inventors: Christian Kruger, Saulheim (DE); Ulrike Hees, Mannheim (DE); Richard Van Gelder, Speyer (DE); Peter Fuber, Habloch (DE); Lothar Schulz, Nubloch (DE); Hans-Gumer Bohrmann, Ludwigshafen (DE); Dieter Puttner, Sandhausen (DE); Sophia Ebert, Mannheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/529,210

(22) PCT Filed: Sep. 25, 2003
(86) PCT No.: PCT/EP03/10656

§ 371 Date: Oct. 31, 2005

(30) Foreign Application Priority Data
Sep. 27, 2002 (DE) 102 45 209.1

(51) Int. Cl. G01D 11/00

(52) U.S. Cl. 347/100

(57) ABSTRACT

Disclosed are recording fluids, preferably inks for the ink jet process, containing random polyurethane copolymers and one or more melamine derivatives as crosslinkers.

The present invention relates to recording fluids, especially inks for ink jet printing.

Inks for use in the ink jet process (such as Piezo Ink Jet, continuous Ink Jet, Valve Jet) have to meet a whole series of requirements. They have to have a viscosity and surface tension suitable for printing, they have to be stable in storage, i.e., they should not coagulate or flocculate, and they must not lead to cloggage of the printer nozzle, which can be problematical especially in the case of pigmented inks, i.e., containing colorant particles which are insoluble in the medium. Stability in storage further in storage further requires of these inks that the dispersed colorant particles do not sediment. Furthermore, in the case of Continuous Ink Jet the inks shall be stable to the addition of conducting salts and be free from any tendency to flock out with an increase in the ion content. In addition, the prints obtained have to meet colorists' requirements, i.e., show brilliance and depth of shade, and have good fastness properties, for example, lightfastness, and good drying characteristics.

These requirements can be met by means of suitable dispersing additives. The literature discloses various dispersing additives whose properties have to be further optimized, however.

After a substrate, for example a textile substrate, has been printed, the inks should remain on the substrate and should certainly not be redispersed in a wash liquor used for washing the textile for example. This requires the addition of a binder to the ink or a corresponding treatment of the textile shortly before or after printing, and this requires an additional operation.

WO 00/17250 describes the use of dispersants having a block copolymer structure consisting of a di- or polyfunctional isocyanate and a block which is terminated with a polar group, for example COOH, and whose end group has been reacted with for example polyamides or vinyl-bearing N-containing heterocycles. Inks produced using such dispersants have very good properties with regard to rubfastness and waterfastness, but in the case of prints on textile the level of fixation reveals a need for optimization after several washes. Similarly, fixation decreases substantially in the case of substrates which are bent, folded or creased.

WO 99/41320 describes ink jet printing inks dispersed using polyurethanes having for example dimethylolpropionic acid or polyethylene monomethyl ether as dispersing groups, randomly distributed across the molecule. The inks produced using the polyurethanes described are notable for good storage stability and good to moderate printing properties, especially with regard to nozzle failure, but the fixation of the prints is too low for commercial applications.

WO 99/50364 describes the use of polyurethanes as dispersants in ink jet inks comprising a water-soluble solvent, a water-insoluble solvent and water. The polyurethanes contain dispersing, i.e., water-solubilizing, groups randomly distributed across the molecule. However, the fixation of the ink is still capable of improvement.

EP-A 0 739 959 describes random polyurethane copolymers and their use as dispersants.

WO 00/03081 describes a process for printing textile substrates using the ink jet printing process by pretreatment of the substrate with a binder. This process requires an additional operation. It is economically sensible to develop an ink which renders this additional operation unnecessary. However, prior art dispersants are not useful as an ingredient of these inks.

It is an object of the present invention to remedy the disadvantages of the prior art and provide novel recording fluids which in particular have a low viscosity and produce prints having good fixation, color strength and brilliance and good in-service fastnesses (washfastness and wet and dry rubfastness).

We have found that this object is achieved by recording fluids containing random polyurethane copolymers and melamine derivatives as crosslinkers.

The recording fluids additionally containing organic or inorganic colorants, optionally further dispersants, solvents and also customary additives.

Random polyurethane copolymers

Random polyurethane copolymers are obtained from one or more different di- or polyisocyanates and one or more different further compounds which have at least two isocyanate-reactive groups. The units derived from the diisocyanates on the one hand and the further compounds on the other alternate, and when two or more different isocyanates and two or more different further compounds are used these units will each be present in a random distribution in the polymer formed. Random polyurethane copolymers, accordingly, do not have a block structure.

Polyurethanes for the purposes of the present invention are not only polymers which are exclusively linked by urethane groups but in a more general sense polymers which are obtainable by reaction of di- or polyisocyanates with compounds containing active hydrogen atoms. Polyurethanes for the purposes of the present invention, as well as urethane groups, can also contain urea, allophanate, biuret, carbodiimide, amide, ester, ether, uretonimine, uretidione, isocyanurate or oxazolidine groups. An example of a survey is Kunststoffhandbuch/Saechtling, 26th edition, Carl-Hanser-Verlag, Munich 1995, page 491 ff. More particularly, polyurethanes for the purposes of the present invention can contain urea groups.

To prepare random polyurethane copolymers, one or more diisocyanates are reacted by known methods with one or more compounds bearing two isocyanate-reactive groups. In addition, the reaction mixture may also contain a certain amount of compounds having just one isocyanate-reactive group. The NCO groups of the diisocyanate or diisocyanates can have the same or a different reactivity. Diisocyanates having NCO groups of the same reactivity may be aromatic or aliphatic diisocyanates, preference being given to aliphatic diisocyanates such as tetramethylene diisocyanate, hexamethylene diisocyanate, octamethylene diisocyanate, decamethylene diisocyanate, dodecamethylene diisocyanate, tetradecamethylene diisocyanate, trimethylhexane diisocyanate, tetramethylhexane diisocyanate, 1,4-, 1,3- or 1,2-diisocyanatocyclohexane, 4,4′-di(isocyanatocyclohexyl)methane, 1-isocyanato-3,3,5-trimethyl-5-(isocyanatomethyl)cyclohexane (isophorone diisocyanate) and 2,4- and 2,6-diisocyanato-1-methylcyclohexane, of which hexamethylene diisocyanate (HDI) and isophorone diisocyanate are particularly preferred. Further particularly preferred diisocyanates are m-tetramethylxylene diisocyanate (TMXDI) and 4,4′-diphenylmethane diisocyanate.

Preferred diisocyanates having NCO groups of differing reactivity are the readily and inexpensively available isocyanates such as for example 2,4-tolylene diisocyanate (2,4-TDI), 2,4′-diphenylmethane diisocyanate (2,4′-MDI), triisocyanatotoluene as representatives of aromatic diisocyanates or aliphatic diisocyanates, such as 2-butyl-2-ethylpentamethylene diisocyanate, 2-isocyanatopropylcyclohexyl isocyanate, 2,4,4- or 2,2,4-trimethylhexamethylene diisocyanate, 2,4′-methylenebis(cyclohexyl)diisocyanate and 4-methylcyclohexane-1,3-iisocyanate (H-TDI).

Further examples of isocyanates having groups differing in reactivity are 1,3-phenylene diisocyanate, 1,4-phenylene diisocyanate, 1,5-naphthylene diisocyanate, diphenyl diisocyanate, toluidine diisocyanate and 2,6-tolylene diisocyanate.

It will be appreciated that mixtures of two or more of the aforementioned isocyanates can also be used.

It is also possible to replace fractions of the diisocyanate with polyisocyanates, for example triisocyanate or tetraisocyanate, in order that branches may be incorporated into the polyurethane block.

Examples of compounds bearing two isocyanate-reactive groups such as for example OH, SH, NH₂ or NHR, where R is selected from C₁-C₂-alkyl, are diols and secondary diamines. Preferred examples are secondary diamines, for example 1,4-butylene-N,N′-dimethylamine, and especially linear or branched alkanediols or cycloalkanediols having from 2 to 10 carbon atoms in the alkylene moiety. Preferred candidates are in particular: ethylene glycol, 1,2-propanediol, 1,3-propanediol, 1,4-butanediol, 1,6-hexanediol, neopentyl glycol, cis-1,2-cyclohexanedimethanol, trans-1,2-cyclohexanedimethanol and also trans-1,4-cyclohexanedimethanol. It is also possible to use mixtures of the aforementioned compounds. It is also possible to use compounds containing various isocyanate-reactive groups, for example thioglycol or ethanolamine or methyldiethanolamine.

Examples of compounds which bear just one isocyanate-reactive group and which may be included in a certain proportion, for example up to 20% by weight, preferably up to 10% by weight, based on the polyurethane, are methyl-terminated polyethermonools or polyestermonools.

Preference is given to reacting a diisocyanate with two or more different diols.

Suitable catalysts to speed especially reaction between the NCO groups of the diisocyanates and the hydroxyl groups and amino groups of the compounds bearing two isocyanate-reactive groups are the well-known tertiary amines, for example triethylamine, dimethylcyclohexylamine, N-methylmorpholine, N,N′-dimethylpiperazine, 2-dimethyl-aminoethoxy)ethanol, diazabicyclo(2.2.2)octane and the like and especially organic metal compounds such as titanate esters, iron compounds such as for example iron(III) acetylacetonate, tin compounds, for example tin diacetate, tin dioctanoate, tin dilaurate or the dialkyl derivatives of tin dialkyl salts of aliphatic carboxylic acids such as dibutyltin diacetate, dibutyltin dilaurate or the like. The catalysts are customarily used in amounts of from 0.0001 to 0.1 part by weight per 100 parts by weight of diol or diamine.

The synthesis of the random polyurethane copolymers is generally carried out without a solvent or in an aprotic solvent, for example in tetrahydrofuran, diethyl ether, diisopropyl ether, chloroform, dichloromethane, di-n-butyl ether, acetone, N-methylpyrrolidone (NMP), xylene, toluene, methyl ethyl ketone (MEK), methyl isobutyl ketone (MIBK) or 1,4-dioxane. Preferred reaction temperatures are in the range from 10° C. to the boiling point of the solvent used. The reaction is generally carried out under atmospheric pressure, but it may also be carried out in autoclaves at up to 20 bar.

Copolymer formation is preferably terminated by addition of a stopper. Useful stoppers include for example secondary amines, alcohols and thiols, preference being given to secondary amines and particular preference to dialkylamines and dialkanolamines. Examples are diethanolamine, diethylamine, dibutylamine and ethanolethylamine.

As well as diisocyanates and diols, hydrophilic groups can be incorporated into the random polyurethane copolymer. The hydrophilic groups are preferably carboxyl groups, which can be introduced for example by means of dihydroxycarboxylic acids such as dimethylolpropionic acid (DMPA) or citric acid. Another embodiment of the present invention introduces a sulfo-containing diol, for example the Michael adduct of diethanolamine with acryloylaminopropanesulfonic acid. Diethylolproionic acid is a most preferred example. It is further possible to incorporate selected diols as additional hydrophilic components: polyethylene glycols having from 2 to 50 ethylene units and a preferred number average molecular weight Mₙ in the range from 900 to 2 000 g, polypropylene glycols having from 2 to 20 propylene units, polytetrahydrofuran derivatives having from 2 to 10 tetramethylene units and also polyesterpolyols, preferably polyesterdiols. Polyesterpolyols are saturated polyesters or polyethers with or without ether groups that contain at least two free hydroxyl groups per molecule, and preferably they contain from two to ten and more preferably precisely two free hydroxyl groups per molecule. The average molecular weights Mₙ of the polyesterpolyols range from 250 to 4000 g/mol and preferably from 450 to 2000 g/mol.

Such polyesterpolyols are obtainable in conventional manner by esterification of one or more dicarboxylic acids or tricarboxylic acids or mixtures of dicarboxylic acids with tricarboxylic acids with diols or triols. The esterification can be carried out in the absence of a solvent or else by azeotropic esterification in the presence of an entrainer. The starting materials for polyesterpolyols are known to one skilled in the art. Preferred dicarboxylic acids include succinic acid, glutaric acid, adipic acid, sebacic acid, pimelic acid, ortho-phthalic acid or their isomers and hydrogenation products and also esterifiable derivatives thereof, for example anhydrides or dialkyl esters, for example dimethyl esters or diethyl esters. Preferred diols include ethylene glycol, 1,2-propanediol, 1,3-propanediol, 1,4-butanediol, 1,6-hexanediol, neopentylglycol, cis-1,2-cyclohexanedimethanol, trans-1,2-cyclohexanedimethanol, polyglycols of the ethylene glycol and 1,2-propanediol type and also diols having at least one further functional group such as for example dimethylolpropionic acid.

Preferred triols are glycerol and trimethylolpropane.

Useful diols further include polycaprolactonediols and polycaprolactonetriols, the preparation of which is likewise known to one skilled in the art.

Useful polyether polyols include for example reaction products of dihydric and/or higher alcohols with one or more equivalents of ethylene oxide and/or propylene oxide. In the case of ethylene oxide-propylene oxide intercondensation products, the reaction can conveniently be controlled so that predominantly primary hydroxyl groups are obtained in the terminal positions. It is further possible to use polybutylene oxides. The average molecular weights Mₙ of the polyetherpolyols range from 250 to 4000 g/mol and preferably from 450 to 2000 g/mol.

For further use of the random polyurethane copolymers, strongly acidic hydrophilic groups such as carboxyl groups and sulfonic acid groups are neutralized with bases. Preferably they are neutralized with volatile bases such as for example ammonia or volatile primary, secondary or tertiary amines, for example methylamine, ethylamine, dimethylamine, diethylamine, trimethylamine, triethylamine, isopropylamine, ethyldiisopropylamine, di-n-butylamine, ethanolamine, diethanolamine, triethanolamine, methyldiethanolamine, n-propyldiethanolamine or n-butyldiethanolamine.

Specific random polyurethane copolymers used in the recording fluids of the present invention are obtained from mixtures of neopentylglycol and polyesterdiols or mixtures of dimethylpropionic acid and polyetherdiols as a diol component and isophorone diisocyanate, 4,4′-diphenyl diisocyanate or hexamethylene diisocyanate as a diisocyanate component.

Crosslinkers

The recording fluids of the present invention contain one or more different melamine derivatives as crosslinkers. Preferred melamine derivatives have the general formula (I) 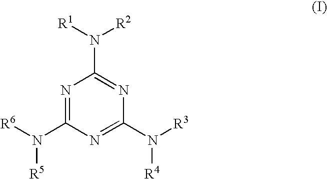
where R¹ to R⁶ are the same or different and are each selected from:
hydrogen or (CH₂O)_{z}—R⁷ or CH₂—OR⁷ or CH(OR⁷)₂ or CH₂—N(R⁷)₂,
where z is from 1 to 10 and each R⁷ may be the same or different and is selected from
hydrogen, C₁-C₁₂-alkyl, branched or unbranched, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl and n-dodecyl; preferably C₁-C₆-alkyl such as methyl, ethyl, n-propyl, isopropyl, n-butyl, isobutyl, sec-butyl, tert-butyl, n-pentyl, isopentyl, sec-pentyl, neopentyl,
1,2-dimethylpropyl, isoamyl, n-hexyl, isohexyl, sec-hexyl, particularly preferably C₁-C₄-alkyl such as methyl, ethyl, n-propyl, isopropyl, n-butyl, isobutyl, sec-butyl and tert-butyl;
alkoxyalkylene, for example (—CH₂—CH₂—O)ₘ—H, (—CHCH₃—CH₂—O)ₘ—H, (—CH₂—CHCH₃—O)ₘ—H, (—CH₂—CH₂—CH₂—CH₂—O)ₘ—H, where m is an integer from 1 to 20, preferably from 1 to 10 and more preferably from 1 to 5.
R¹, R³ and R⁵ are preferably different.

Particularly preferably R¹ and R² are both hydrogen. Particularly preferably R³ and R⁴ are both CH₂—OH. Most preferably, R₁ and R² are both hydrogen and R³ is CH₂—OH.

Melamine derivatives of the general formula (I) are known per se and are commercially obtainable for example as Luwipal® from BASF Aktiengesellschaft and as Cymel® 327 from Cytec. Melamine derivatives for the purposes of the present invention are generally not pure in accordance with any defined formula. It is usual to observe intermolecular rearrangements of R¹ to R⁶, i.e., transacetalization reactions and transaminalization reactions, and also to some extent condensation reactions and elimination reactions. The formula (I) indicated above is to be understood as defining the stoichiometric ratios of the substituents and also encompassing intermolecular rearrangement products and condensation products and elimination products.

The polyurethane random copolymers and melamine derivatives are customarily used in a weight ratio in the range from 0.01:1 to 100:1, preferably from 0.1:1 to 50:1 and more preferably from 1:1 to 10:1.

The present invention further provides crosslinkable dispersing binders which are obtainable by mixing the random polyurethane copolymers and one or more melamine derivatives.

A further aspect of the present invention is a process for preparing the crosslinkable dispersing binders of the present invention. The process of the present invention involves mixing one or more of the above-described random polyurethane copolymers with one or more melamine derivatives, for example in ball mills, stirred media mills, dispensers, dissolvers or basket mills. Examples of such assemblies are commercially available from Getzmann or Skandex.

A further aspect of the present invention is a process for preparing the recording fluids of the present invention. The process comprises intimately mixing one or more of the above-described random polyurethane copolymers with one or more finely divided inorganic or organic colorants, water, optionally one or more organic solvents and one or more melamine derivatives and optionally assistants (additives).

A further aspect of the present invention is a process for preparing colorant preparations using the dispersing binders of the present invention and also a process for preparing recording fluids using the dispersing binders of the present invention and/or the colorant preparations of the present invention.

The colorant preparations according to the invention are obtained by intensively mixing the dispersing binder systems according to the invention with one or more colorants sparingly soluble in water or the water/solvent mixture, for example in a ball mill. The colorant preparations according to the invention are preferably prepared by not isolating the crosslinkable dispersing binder systems and mixing the random polyurethane copolymers with one or more melamine derivatives, water, optionally one or more organic solvents and one or more sparingly water-soluble colorants, for example in a ball mill, at pressures from 1 to 10 bar and from 0 to 250° C. Ball-milled colorant preparations are also known as grinds.

The colorant preparations according to the invention, as well as the random polyurethane copolymers, include water and also finely divided organic or inorganic colorants, i.e., pigments as defined in German standard specification DIN 55944, that are dispersed and substantially insoluble in water and/or in the water-solvent mixture. It will be appreciated that the colorant preparations of the invention may also include colorant mixtures, but preferably only one colorant is present. By way of brightening agents, these pigments preparations may include dyes, especially direct, acid or reactive dyes, that are similar in hue to the pigment.

There now follow examples of useful pigments, vat dyes being included among the organic pigments on account of the overlap with organic pigments.

Organic Pigments:

monoazo pigments: C.I. Pigment Brown 25; C.I. Pigment Orange 5, 13, 36 and 67; C.I. Pigment Red 1, 2, 3, 5, 8, 9, 12, 17, 22, 23, 31, 48:1, 48:2, 48:3, 48:4, 49, 49:1, 52:1, 52:2, 53, 53:1, 53:3, 57:1, 63, 112, 146, 170, 184, 210, 245 and 251; C.I. Pigment Yellow 1, 3, 73, 74, 65, 97, 151 and 183;
disazo pigments: C.I. Pigment Orange 16, 34 and 44; C.I. Pigment Red 144, 166, 214 and 242; C.I. Pigment Yellow 12, 13, 14, 16, 17, 81, 83, 106, 113, 126, 127, 155, 174, 176 and 188;
anthanthrone pigments: C.I. Pigment Red 168 (C.I. Vat Orange 3);
anthraquinone pigments: C.I. Pigment Yellow 147 and 177; C.I. Pigment Violet 31;
anthraquinone pigments: C.I. Pigment Yellow 147 and 177; C.I. Pigment Violet 31;
anthrapyrimidine pigments: C.I. Pigment Yellow 108 (C.I. Vat Yellow 20);
quinacridone pigments: C.I. Pigment Red 122, 202 and 206; C.I. Pigment Violet 19;
quinophthalone pigments: C.I. Pigment Yellow 138;
dioxazine pigments: C.I. Pigment Violet 23 and 37;
flavanthrone pigments: C.I. Pigment Yellow 24 (C.I. Vat Yellow 1);
indanthrone pigments: C.I. Pigment Blue 60 (C.I. Vat Blue 4) and 64 (C.I. Vat Blue 6);
isoindoline pigments: C.I. Pigment Orange 69; C.I. Pigment Red 260; C.I. Pigment Yellow 139 and 185;
isoindolinone pigments: C.I. Pigment Orange 61; C.I. Pigment Red 257 and 260; C.I. Pigment Yellow 109, 110, 173 and 185;
isoviolanthrone pigments: C.I. Pigment Violet 31 (C.I. Vat Violet 1);
metal complex pigments: C.I. Pigment Yellow 117, 150 and 153; C.I. Pigment Green 8;
perinone pigments: C.I. Pigment Orange 43 (C.I. Vat Orange 7); C.I. Pigment Red 194 (C.I. Vat Red 15);
perylene pigments: C.I. Pigment Black 31 and 32; C.I. Pigment Red 123, 149, 178, 179 (C.I. Vat Red 23), 190 (C.I. Vat Red 29) and 224; C.I. Pigment Violet 29;
phthalocyanine pigments: C.I. Pigment Blue 15, 15:1, 15:2, 15:3, 15:4, 15:6 and 16; C.I. Pigment Green 7 and 36;
pyranthrone pigments: C.I. Pigment Orange 51; C.I. Pigment Red 216 (C.I. Vat Orange 4);
thioindigo pigments: C.I. Pigment Red 88 and 181 (C.I. Vat Red 1); C.I. Pigment Violet 38 (C.I. Vat Violet 3);
triarylcarbonium pigments: C.I. Pigment Blue 1, 61 and 62; C.I. Pigment Green 1; C.I. Pigment Red 81, 81:1 and 169; C.I. Pigment Violet 1, 2, 3 and 27; C.I. Pigment Black 1 (aniline black);
C.I. Pigment Yellow 101 (aldazine yellow);
C.I. Pigment Brown 22;
   Vat Dyes (in Addition to those Already Mentioned Above):
C.I. Vat Yellow 2, 3, 4, 5, 9, 10, 12, 22, 26, 33, 37, 46, 48, 49 and 50;
C.I. Vat Orange 1, 2, 5, 9, 11, 13, 15, 19, 26, 29, 30 and 31;
C.I. Vat Red 2, 10, 12, 13, 14, 16, 19, 21, 31, 32, 37, 41, 51, 52 and61;
C.I. Vat Violet 2, 9, 13, 14, 15, 17 and 21;
C.I. Vat Blue 1 (C.I. Pigment Blue 66), 3, 5, 10, 12, 13, 14, 16, 17, 18, 19, 20, 22, 25, 26, 29, 30, 31, 35, 41, 42, 43, 64, 65, 66, 72 and 74;
C.I. Vat Green 1, 2, 3, 5, 7, 8, 9, 13, 14, 17, 26, 29, 30, 31, 32, 33, 40, 42, 43, 44 and 49;
C.I. Vat Brown 1, 3, 4, 5, 6, 9, 11, 17, 25, 32, 33, 35, 38, 39, 41, 42, 44, 45, 49, 50, 55, 57, 68, 72, 73, 80, 81, 82, 83 and 84;
C.I. Vat Black 1, 2, 7, 8, 9, 13, 14, 16, 19, 20, 22, 25, 27, 28, 29, 30, 31, 32, 34, 36, 56, 57, 58, 63, 64 and 65;
   Inorganic Pigments:
white pigments: titanium dioxide (C.I. Pigment White 6), zinc white, pigment grade zinc oxide; zinc sulfide, lithopone; lead white;
black pigments: iron oxide black (C.I. Pigment Black 11), iron manganese black, spinel black (C.I. Pigment Black 27); carbon black (C.I. Pigment Black 7);
color pigments: chromium oxide, chromium oxide hydrate green; chrome green (C.I. Pigment Green 48); cobalt green (C.I. Pigment Green 50); ultramarine green; cobalt blue (C.I. Pigment Blue 28 and 36); ultramarine blue; iron blue (C.I. Pigment Blue 27); manganese blue; ultramarine violet; cobalt violet and manganese violet; iron oxide red (C.I. Pigment Red 101); cadmium sulfoselenide (C.I. Pigment Red 108); molybdate red (C.I. Pigment Red 104); ultramarine red;
   iron oxide brown, mixed brown, spinel and corundum phases (C.I. Pigment Brown 24, 29 and 31), chrome orange;
   iron oxide yellow (C.I. Pigment Yellow 42); nickel titanium yellow (C.I. Pigment Yellow 53; C.I. Pigment Yellow 157 and 164); chrome titanium yellow; cadmium sulfide and cadmium zinc sulfide (C.I. Pigment Yellow 37 and 35); chrome yellow (C.I. Pigment Yellow 34), zinc yellow, alkaline earth metal chromates; Naples yellow; bismuth vanadate (C.I. Pigment Yellow 184);
interference pigments: metallic effect pigments based on coated metal platelets; pearl luster pigments based on mica platelets coated with metal oxide; liquid crystal pigments.

Preferred pigments in this context are monoazo pigments (especially laked BONS pigments, Naphtol AS pigments), disazo pigments (especially diaryl yellow pigments, bisacetoacetanilide pigments, disazopyrazolone pigments), quinacridone pigments, quinophthalone pigments, perinone pigments, phthalocyanine pigments, triarylcarbonium pigments (alkali blue pigments, laked rhodamines, dye salts with complex anions), isoindoline pigments and carbon blacks.

Examples of particularly preferred pigments are specifically: C.I. Pigment Yellow 138, C.I. Pigment Red 122 and 146, C.I. Pigment Violet 19, C.I. Pigment Blue 15:3 and 15:4, C.I. Pigment Black 7, C.I. Pigment Orange 5, 38 and 43 and C.I. Pigment Green 7.

These pigments are very useful for preparing ink-jet ink sets based on colorant preparations according to the invention. The level of each pigment in the individual inks shall be conformed to the respective requirements (e.g., trichromism).

The Following Pigment Combinations are Particularly Recommended:

C.I. Pigment Yellow 138, C.I. Pigment Violet 19, C.I. Pigment Blue 15:3 and C.I. Pigment Black 7;
C.I. Pigment Yellow 138, C.I. Pigment Red 122, C.I. Pigment Blue 15:3 or 15:4 and C.I. Pigment Black 7;
C.I. Pigment Yellow 138, C.I. Pigment Violet 19, C.I. Pigment Blue 15:3, C.I. Pigment Black 7, C.I. Pigment Orange 43 and C.I. Pigment Green 7;
C.I. Pigment Yellow 138, C.I. Pigment Red 122, C.I. Pigment Blue 15:3 or 15:4, C.I. Pigment Black 7, C.I. Pigment Orange 5 and C.I. Pigment Green 7;
C.I. Pigment Yellow 138, C.I. Pigment Red 122, C.I. Pigment Blue 15:3 or 15:4, C.I. Pigment Black 7, C.I. Pigment Orange 38 and C.I. Pigment Green 7;
C.I. Pigment Yellow 138, C.I. Pigment Red 122, C.I. Pigment Blue 15:3 or 15:4, C.I. Pigment Black 7, C.I. Pigment Orange 43 and C.I. Pigment Green 7.

The colorant preparations according to the invention generally include from 0.01 to 20% by weight, preferably from 0.2 to 10% by weight and more preferably from 1 to 6% by weight of pigment.

The undissolved, dispersed pigments should be very finely divided. Preferably 95% and more preferably 99% of the colorant particles have an average particle diameter of 1 μm, preferably 0.5 μm and more preferably up to 0.2 μm. The average particle diameter is preferably at least 0.05 μm.

Water is the main constituent of the colorant preparations according to the invention, preference being given to demineralized water as obtainable for example through the use of an ion exchanger. The water content is customarily in the range from 30 to 95% by weight. The water content of preparations according to the invention is preferably in the range from 40 to 60% by weight.

The colorant preparations according to the invention generally contain from 1 to 40% by weight and preferably from 5 to 30% by weight of the random polyurethane copolymers.

The colorant preparations according to the invention may additionally include one or more organic solvents. Low molecular weight polytetrahydrofuran is a preferred additive, and it can be used alone or preferably mixed with one or more high-boiling water-soluble or -miscible organic solvents.

The preferred polytetrahydrofuran customarily has an average molecular weight M_{w} of from 150 to 500 g/mol, preferably from 200 to 300 g/mol and more preferably of about 250 g/mol. Polytetrahydrofuran is preparable in known manner by cationic polymerization of tetrahydrofuran. The products are linear polytetramethylene glycols.

Other organic solvents used as an additive are generally high-boiling and hence water-retaining organic solvents that are soluble in or miscible with water. High-boiling solvents are solvents having a boiling point>100° C.

Use solvents include polyhydric alcohols, preferably branched and unbranched polyhydric alcohols containing from 2 to 8 and especially from 3 to 6 carbon atoms, such as ethylene glycol, 1,2-propylene glycol, 1,3-propylene glycol or glycerol.

Useful solvents further include polyethylene glycols and polypropylene glycols (which is also to be understood as meaning the lower polymers (di-, tri- and tetramers)) and their mono (especially C₁-C₆, in particular C₁-C₄) alkyl ethers. Preference is given to polyethylene and polypropylene glycols having average molecular weights of from 100 to 1500 g/mol, in particular from 200 to 800 g/mol, mainly from 300 to 500 g/mol. Examples are diethylene glycol, triethylene glycol, tetraethylene glycol, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, di-, tri- and tetra-1,2- and -1,3-propylene glycol and di-tri- and tetra-1,2- and -1,3-propylene glycol monomethyl, monoethyl, monopropyl and monobutyl ether.

Useful solvents further include pyrrolidone and N-alkylpyrrolidones whose alkyl chain preferably contains from 1 to 4, especially 1 or 2, carbon atoms. Examples of useful alkylpyrrolidones are N-methylpyrrolidone, N-ethylpyrrolidone and N-(2-hydroxyethyl)pyrrolidone.

Examples of particularly preferred solvents are 1,2-propylene glycol, 1,3-propylene glycol, glycerol, sorbitol, diethylene glycol, polyethylene glycol (M_{w} from 300 to 500 g/mol), diethylene glycol monobutyl ether, triethylene glycol mono-n-butyl ether, pyrrolidone, N-methylpyrrolidone and N-(2-hydroxyethyl)pyrrolidone.

The polytetrahydrofuran may also be mixed with one or more (e.g., two, three or four) of the abovementioned solvents.

The colorant preparations according to the invention generally include from 0.1 to 40% by weight, preferably from 2.5 to 30% by weight, more preferably from 5 to 25% by weight and most preferably from 10 to 20% by weight of further solvents (different from water).

The solvent components, including especially the particularly preferred solvent combinations mentioned, may advantageously be augmented by urea (generally from 0.5 to 3% by weight, based on the weight of the colorant preparation), which further enhances the water-retaining effect of the solvent mixture.

The colorant preparations according to the invention may include further assistants of the type which are customary especially for aqueous ink jet inks and in the printing and coatings industry. Examples of such assistants include preservatives such as for example 1,2-benzisothiazolin-3-one (commercially available as Proxel brands from Avecia Lim.) and its alkali metal salts, glutaraldehyde and/or tetramethylolacetylenediurea.

The present invention further provides for the use of the colorant preparations according to the invention for producing aqueous inks for ink jet printing, a process for producing inks for ink jet printing using the colorant preparations according to the invention and the inks thus produced.

The inks according to the invention are produced by diluting the colorant preparations according to the invention with water. As well as water, further solvents and assistants can be added in the operation.

Water is the main constituent of the inks according to the invention, preference being given to demineralized water as obtainable for example through the use of an ion exchanger. The water content is customarily in the range from 50 to 95% by weight. The water content of inks according to the invention is preferably in the range from 60 to 80% by weight.

The inks according to the invention generally contain from 0.1 to 25% by weight and preferably from 0.5 to 10% by weight of polyurethane random copolymers according to the invention.

The inks according to the invention may additionally include organic solvents as a further component. Low molecular weight polytetrahydrofuran is a preferred additive, and it can be used alone or preferably mixed with one or more high-boiling water-soluble or water-miscible organic solvents.

The polytetrahydrofuran preferably used customarily has an average molecular weight M_{w} of from 150 to 500 g/mol, preferably from 200 to 300 g/mol and more preferably of about 250 g/mol.

When polytetrahydrofuran is present in a mixture with further organic solvents, the invention provides that the solvents used be high-boiling and hence water-retaining organic solvents that are soluble in or miscible with water. High-boiling solvents are solvents having a boiling point>100° C.

Useful solvents include polyhydric alcohols, preferably branched and unbranched polyhydric alcohols containing from 2 to 8 and especially from 3 to 6 carbon atoms, such as ethylene glycol, 1,2-propylene glycol, 1,3-propylene glycol or glycerol.

Useful solvents further include polyethylene glycols and polypropylene glycols, which is also to be understood as meaning the lower polymers (di-, tri- and tetramers) and their mono (especially C₁-C₆, in particular C₁-C₄) alkyl ethers. Preference is given to polyethylene and polypropylene glycols having average molecular weights of from 100 to 1500 g/mol, in particular from 200 to 800 g/mol, mainly from 300 to 500 g/mol. Examples are diethylene glycol, triethylene glycol, tetraethylene glycol, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, di-, tri- and tetra-1,2- and -1,3-propylene glycol and di-, tri- and tetra-1,2- and -1,3-propylene glycol monomethyl, monoethyl, monopropyl and monobutyl ether.

Useful solvents further include pyrrolidone and N-alkylpyrrolidones whose alkyl chain preferably contains from 1 to 4, especially 1 or 2, carbon atoms. Examples of useful alkylpyrrolidones are N-methylpyrrolidone, N-ethylpyrrolidone and N-(2-hydroxyethyl)pyrrolidone.

Examples of particularly preferred solvents are 1,2-propylene glycol, 1,3-propylene glycol, glycerol, sorbitol, diethylene glycol, polyethylene glycol (M_{w} from 300 to 500 g/mol), diethylene glycol monobutyl ether, triethylene glycol mono-n-butyl ether, pyrrolidone, N-methylpyrrolidone and N-(2-hydroxyethyl)pyrrolidone.

The polytetrahydrofuran may also be mixed with one or more (e.g., two, three or four) of the abovementioned solvents.

The inks according to the invention generally contain from 0.1 to 40% by weight, preferably from 5 to 30% by weight, more preferably from 10 to 25% by weight and most preferably from 10 to 20% by weight of further solvents (different from water).

The solvent components, including especially the aforementioned particularly preferred solvent combinations, may advantageously be augmented by urea (generally from 0.5 to 3% by weight, based on the weight of the colorant preparation), which further enhances the water-retaining effect of the solvent mixture.

Useful additives further include erythritol, pentaerythritol, pentitols such as arabitol, adonitol and xylitol and hexitols such as sorbitol, mannitol and dulcitol.

The inks according to the invention may include further assistants of the type which are customary especially for aqueous ink jet inks and in the printing and coatings industry. Examples of such assistants include preservatives such as for example 1,2-benzisothiazolin-3-one (commercially available as Proxel brands from Avecia Lim.) and its alkali metal salts, glutardialdehyde and/or tetramethylolacetylenediurea, protectols, antioxidants, degassers/defoamers (such as acetylenediols and ethoxylated acetylenediols, which customarily contain from 20 to 40 mol of ethylene oxide per mole of acetylenediol and also have a dispersing effect), viscosity regulators, flow agents, wetters (e.g., wetting surfactants based on ethoxylated or propoxylated fatty or oxo alcohols, propylene oxide/ethylene oxide block copolymers, ethoxylates of oleic acid or alkylphenols, alkylphenol ether sulfates, alkyl polyglycosides, alkyl phosphonates, alkylphenyl phosphonates, alkyl phosphates, alkylphenyl phosphates or preferably polyether siloxane copolymers, especially alkoxylated 2-(3-hydroxypropyl)heptamethyl trisiloxanes, which generally have a block of from 7 to 20, preferably from 7 to 12, ethylene oxide units and a block of from 2 to 20, preferably from 2 to 10 propylene oxide units and may be present in the colorant preparations in amounts of from 0.05 to 1% by weight), anti-settlers, luster improvers, lubricants, adhesion improvers, anti-skinning agents, delusterants, emulsifiers, stabilizers, water repellents, light control additives, hand improvers, antistats and bases such as triethanolamine or acids, especially carboxylic acids such as lactic acid or citric acid, for regulating the pH. If such assistants are part of the pigment preparations of the invention, their total amount is generally 2% by weight, especially 1% by weight, based on the weight of the colorant preparation.

The inks according to the invention customarily have a dynamic viscosity of from 1 to 20 mPa·s and preferably from 2 to 15 mPa·s, as measured using a rotary viscometer from Haake in accordance with German standard specification DIN 53019-1.

The surface tension of the inks according to the invention is generally in the range from 24 to 70 mN/m and especially in the range from 30 to 60 mN/m, as measured using a K 10 digital tensiometer from Krüss at room temperature. The pH of the colorant preparations according to the invention is generally in the range from 5 to 10 and preferably in the range from 7 to 9, as measured using a 763 pH meter from Knick.

The inks according to the invention have a particularly low kinematic viscosity, especially when compared with inks containing a conventional polymeric binder.

The inks according to the invention may be formulated by mixing one or more random polyurethane copolymers according to the invention with water, with one or more pigments and with one or more melamine derivatives and also with or without additives to form grinds as described above. However, it is possible for the melamine derivative or derivatives not to be added until the dilution with water and thus to the final formulation of the ink.

A further aspect of the present invention is a process for printing sheetlike or three-dimensional substrates by the ink jet process using the inks according to the invention. To this end, the colorant preparations according to the invention are printed onto the substrate. In the ink jet process, the typically aqueous inks are sprayed as small droplets directly onto the substrate. There is a continuous form of the process, in which the ink is pressed at a uniform rate through a nozzle and the jet is directed onto the substrate by an electric field depending on the pattern to be printed, and there is an interrupted or drop-on-demand process, in which the ink is expelled only where a colored dot is to appear, the latter form of the process employing either a piezoelectric crystal or a heated hollow needle (bubble jet process) to exert pressure on the ink system and so eject an ink droplet. These techniques are described in Text. Chem. Color 19 (1987), No. 8, 23-29, and 21 (1989), No. 6, 27-32.

The inks of the invention are particularly useful as inks for the continuous jet process or the process employing a piezoelectric crystal.

The areas printed by the ink jet process are customarily treated with heat in order that the prints may be fixed and the dispersing binder system may be crosslinked. The heating may be effected using steam or hot air for example. A customary temperature range is from 150 to 180° C. for from 5 to 8 minutes. In the case of hot air, it is advisable to treat the printed textile at from 180 to 200° C. for about one minute.

A further embodiment of the present invention comprises a crosslinking operation initiated thermally or by actinic radiation, preferably in the UV region.

Useful substrate materials include:

coated or uncoated cellulosics such as paper, paperboard, cardboard, wood and woodbase,
coated or uncoated metallic materials such as foils, sheets or workpieces composed of aluminum, iron, copper, silver, gold, zinc or alloys thereof,
coated or uncoated silicatic materials such as glass, porcelain and ceramics,
polymeric materials of any kind such as polystyrene, polyarnides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers and block copolymers, biodegradable polymers and natural polymers such as gelatin,
textile materials such as fibers, yarns, threads, knits, wovens, nonwovens and garments composed of polyester, modified polyester, polyester blend fabrics, cellulosics such as cotton, cotton blend fabrics, jute, flax, hemp and ramie, viscose, wool, silk, polyamide, polyamide blend fabrics, polyacrylonitrile, triacetate, acetate, polycarbonate, polypropylene, polyvinyl chloride, polyester microfibers and glass fiber fabric,
leather—both natural and artificial—in the form of smooth leather, nappa leather or suede leather,
comestibles and cosmetics.

The inks according to the invention are notable for advantageous application properties, especially good start-of-print behavior and good sustained use behavior (kogation) and also good drying characteristics. They produce printed images of high quality, i.e., high brilliance and depth of shade and also high rubfastness, lightfastness, waterfastness and wetrubfastness. They are particularly useful for printing textile. It is particularly advantageous that the subject process for printing textiles can be performed particularly rapidly and at high throughput per unit time. It was also found that fixation of the print is excellent even after several washes. Similarly, fixation is excellent even in the case of substrates which are singly or repeatedly bent, folded or creased.

The present invention further provides substrates, especially textile substrates, which have been printed by one of the abovementioned processes according to the invention and are notable for particularly crisply printed images or drawings possessing excellent fixation.

### EXAMPLES

### Example 1

Preparation of a Random Polyurethane

6.75 g of neopentylglycol, 7.03 g of dimethylolpropionic acid, 51.95 g of a polyesterdiol and 53.01 g of 4,4′-diphenylmethane diisocyanate are dissolved in 118.74 g of tetrahydrofuran and reacted under reflux after addition of one drop of dibutyltin dilaurate. The end of the reaction is detected by complete reaction of isocyanate. After cooling with an ice bath, the reaction solution is admixed with 6.25 g of diethanolamine (dissolved in 6.25 g of THF) and neutralized with 5.40 g of triethylamine. After addition of 315 g of water, THF is distilled off.

### Example 2

Preparation of a Random Polyurethane

22.70 g of neopentylglycol, 23.60 g of dimethylolpropionic acid, 175.3 g of a polyesterdiol and 178.40 g of 4,4′-diphenylmethane diisocyanate are dissolved in 400 g of anhydrous acetone and reacted under reflux after addition of one drop of dibutyltin dilaurate. The end of the reaction is detected by complete reaction of isocyanate. After cooling with an ice bath, the reaction solution is admixed with 17.80 g of diethanolamine (dissolved in 61.40 g of acetone) and neutralized with 17.80 g of triethylamine. After addition of 500 g of water, acetone is distilled off.

### Example 3

Production of a Colorant Preparation

The grinds for the organic pigments were produced on a Skandex using 60 g of glass balls 0.25-0.55 mm in size. The recipe is reproduced in Table 1. The weighing in of the liquid raw materials and of the glass balls and the pigment was followed by shaking in a (Skandex) shaking apparatus. A sample of the preparation was then taken to determine the particle size. The pH was measured and, if necessary, raised to 7-8 with triethanolamine.

TABLE 1
Colorant preparation recipe

| | | |
|---|---|---|
| 6.00 | g | P.R. 122 pigment |
| 18.02 | g | Dispersing binder of Example 1, 33% by weight |
| 0.30 | g | Proxel XL2 biocide |
| 2.69 | g | MF resin |
| 29.94 | g | DM water |

After 4 hours of dispersion in the Skandex, the particle size was found to be 155 nm as measured using a Coulter LS230 particle size measuring instrument.

### Example 4

Production of an Ink

The ink was produced to the recipe of Table 2 by dissolving urea in water. The solvents reported in Table 2 were then added in succession and thoroughly mixed in on a roll mill. Finally, the colorant preparation was added and the mixture was further stirred for 15 minutes.

TABLE 2
Recipe for producing a magenta ink

| | | |
|---|---|---|
| 25.00 | g | Color preparation of Example 3, 10% by weight |
| 1.00 | g | Urea |
| 3.00 | g | Butyltriglycol (water retention aid) |
| 7.00 | g | Pluriol E 400 to adjust surface tension |
| 8.00 | g | Glycerol |
| 0.50 | g | Proxel XL 2 biocide |
| 0.50 | g | Tego Wet 260 wetting agent |
| 53.00 | g | DM water |

The viscosity of the ink at 25° C. was 3.85 mPas and its pH was 8.57. The ink was suction filtered through a glass fiber filter (1 μm cutoff size). The inks were then printed onto paper using an Epson 3000 720 dpi piezo printer. The print test on paper produced a nonstripey print at a maximum failure rate of one nozzle per 25 pages.

### Example 5

The prints were then tested for rubfastness in accordance with ISO standard 105-D02: 1993 and for washfastness in accordance with ISO standard 105-C06: 1994. Table 3 summarizes the results (1=very bad, 5=very good):

TABLE 3
Fastnesses of prints with magenta ink of Example 4

| Substrate | Rubfastness (dry) | Rubfastness (wet) | Washfastness |
|---|---|---|---|
| Cotton | 4-5 | 3-4 | 4-5 |
| Polyester/cotton | 4 | 3 | 3-4 |
| blend (67%/33%) | | | |
| Polyester | 4 | 3-4 | 3-4 |
| staple fiber | | | |
| Polyester satin | 4-5 | 4-5 | 3-4 |

1. A method for printing sheetlike or three-dimensional substrates by the ink jet process comprising utilizing a thermally crosslinkable, aqueous recording fluid containing random polyurethane copolymers and one or more melamine derivatives as crosslinkers in a printing process.

2. The method as claimed in claim 1, wherein the recording fluid contains one or more melamine derivatives of the general formula (I) 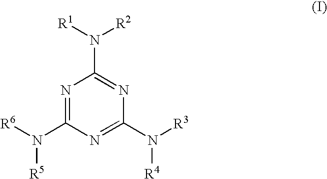
where:
R¹ to R⁶ are the same or different and are each selected from hydrogen, (CH₂O)_{z}—R⁷, CH₂—OR⁷, CH(OR⁷)₂ and CH₂—N(R₇)₂
where z is from 1 to 10 and each R⁷ is the same or different and is selected from
hydrogen, C₁-C₁₂-alkyl, branched or unbranched;
alkoxyalkylene, (—CH₂—CH₂—O)ₘ—H, (—CHCH₃—CH₂—O)ₘ—H, (—CH₂—CHCH₃—O)ₘ—H, (—CH₂—CH₂—CH₂—CH₂—O)ₘ—H, where m is an integer from 1 to 20.

3. The method as claimed in claim 2, wherein R¹ and R² are each hydrogen in the formula (I).

4. The method as claimed in claim 2, wherein R³ is CH₂OH in the formula (I).

5. Printed sheetlike or three-dimensional substrates obtained by the method of claim 1.

6. A process for preparing colorant preparations for recording fluids as defined in claim 1 comprising a mixture of random polyurethane copolymers and one or more melamine derivatives as dispersing binders, water, optionally one or more organic solvents and a finely divided inorganic or organic colorant, which comprises mixing together in a ball mill dispersing binders, water, optionally one or more organic solvents and a finely divided inorganic or organic colorant.

7. Colorant preparations for recording fluids, obtained by the process of claim 6.
